(19) United States
(12) Patent Application Publication
(10) Pub. No.: US 2006/0136210 A1
(43) Pub. Date: Jun. 22, 2006

(54) System and method for tying variance vectors for speech recognition

(75) Inventors: Xavier Menendez-Pidal, Los Gatos, CA (US); Ajay Madhukar Patrikar, Herndon, VA (US)

Correspondence Address: Gregory J. Koerner;REDWOOD PATENT LAW, Suite 205, 1291 East Hillsdale Boulevard, Foster City, CA, 94404, US

(73) Assignees: Sony Corporation; Sony Electronics Inc.

(21) Appl. No.: 11/014,462

(22) Filed: Dec. 16, 2004

(51) Int. Cl. G10L 15/00

(52) U.S. Cl. 704/256.8

(57) ABSTRACT

A system and method for implementing a speech recognition engine includes acoustic models that the speech recognition engine utilizes to perform speech recognition procedures. An acoustic model optimizer performs a vector quantization procedure upon original variance vectors initially associated with the acoustic models. In certain embodiments, the vector quantization procedure may be performed as a block vector quantization procedure or as a subgroup vector quantization procedure. The vector quantization procedure produces a reduced number of tied variance vectors for optimally implementing the acoustic models.

### BACKGROUND SECTION

1. Field of Invention

This invention relates generally to electronic speech recognition systems, and relates more particularly to a system and method for tying variance vectors for speech recognition.

2. Background

Implementing robust and effective techniques for system users to interface with electronic devices is a significant consideration of system designers and manufacturers. Voice-controlled operation of electronic devices often provides a desirable interface for system users to control and interact with electronic devices. For example, voice-controlled operation of an electronic device may allow a user to perform other tasks simultaneously, or can be advantageous in certain types of operating environments. In addition, hands-free operation of electronic devices may also be desirable for users who have physical limitations or other special requirements.

Hands-free operation of electronic devices may be implemented by various speech-activated electronic devices. Speech-activated electronic devices advantageously allow users to interface with electronic devices in situations where it would be inconvenient or potentially hazardous to utilize a traditional input device. However, effectively implementing such speech recognition systems creates substantial challenges for system designers.

For example, enhanced demands for increased system functionality and performance require more system processing power and require additional memory resources. An increase in processing or memory requirements typically results in a corresponding detrimental economic impact due to increased production costs and operational inefficiencies.

Furthermore, enhanced system capability to perform various advanced operations provides additional benefits to a system user, but may also place increased demands on the control and management of various system components. Therefore, for at least the foregoing reasons, implementing a robust and effective method for a system user to interface with electronic devices through speech recognition remains a significant consideration of system designers and manufacturers.

### SUMMARY

In accordance with the present invention, a system and method are disclosed for configuring acoustic models for use by a speech recognition engine to perform speech recognition procedures. The acoustic models are optimally configured by utilizing compressed variance vectors to significantly conserve memory resources during speech recognition procedures.

During a block vector quantization procedure, a set of original acoustic models are initially trained using a representative training database. A vector compression target value may then be defined to specify a final target number of compressed variance vectors for utilization in optimized acoustic models. An acoustic model optimizer then accesses all variance vectors for all original acoustic models as a single block.

The acoustic model optimizer next performs a block vector quantization procedure upon all of the variance vectors to produce a single reduced set of compressed variance vectors. The reduced set of compressed variance vectors may then be utilized to implement the optimized acoustic models for efficiently performing speech recognition procedures.

In an alternate embodiment that utilizes subgroup variance quantization procedures, a set of original acoustic models are initially trained on a training data base. A subgroup category may then be selected by utilizing any appropriate techniques. For example, a subgroup category may be defined at the phone level, at the state level, or at a state cluster level, depending upon the level of granularity desired when performing the corresponding subgroup vector quantization procedures.

The acoustic model optimizer then separately accesses the variance vector subgroups from the original acoustic models. A vector compression factor may then be defined to specify a compression rate for each subgroup. For example, a vector compression factor of four would compress thirty-six original variance vectors into six compressed variance vectors.

The acoustic model optimizer then performs separate subgroup vector quantization procedures upon the variance vector subgroups to produce corresponding compressed variance vector subgroups. Each compressed variance vector subgroup may then be utilized to implement corresponding optimized acoustic models for performing speech recognition procedures. For at least the foregoing reasons, the present invention therefore provides an improved system and method for efficiently implementing variance vectors for speech recognition.

### BRIEF DESCRIPTION OF THE DRAWINGS

FIG. 1 is a block diagram for one embodiment of an electronic device, in accordance with the present invention;

FIG. 2 is a block diagram for one embodiment of the memory of FIG. 1, in accordance with the present invention;

FIG. 3 is a block diagram for one embodiment of the speech recognition engine of FIG. 2, in accordance with the present invention;

FIG. 4 is a block diagram illustrating functionality of the speech recognition engine of FIG. 3, in accordance with one embodiment of the present invention;

FIG. 5 is a diagram for one embodiment of an acoustic model, in accordance with the present invention;

FIG. 6 is a diagram for one embodiment of a Gaussian, in accordance with the present invention;

FIG. 7 is a graph illustrating a means parameter and a variance parameter, in accordance with one embodiment of the present invention;

FIG. 8A is a diagram illustrating one embodiment of a block variance quantization procedure, in accordance with the present invention;

FIG. 8B is a diagram illustrating one embodiment for subgroup variance quantization procedures, in accordance with the present invention; and

FIG. 9 is a graph illustrating a vector quantization procedure, in accordance with one embodiment of the present invention.

### DETAILED DESCRIPTION

The present invention relates to an improvement in speech recognition systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for effectively implementing a speech recognition engine, and includes acoustic models that the speech recognition engine utilizes to perform speech recognition procedures. An acoustic model optimizer performs a vector quantization procedure upon original variance vectors initially associated with the acoustic models. In certain embodiments, the vector quantization procedure is performed as a block vector quantization procedure or as a subgroup vector quantization procedure. The vector quantization procedure produces a reduced number of compressed variance vectors for optimally implementing the acoustic models.

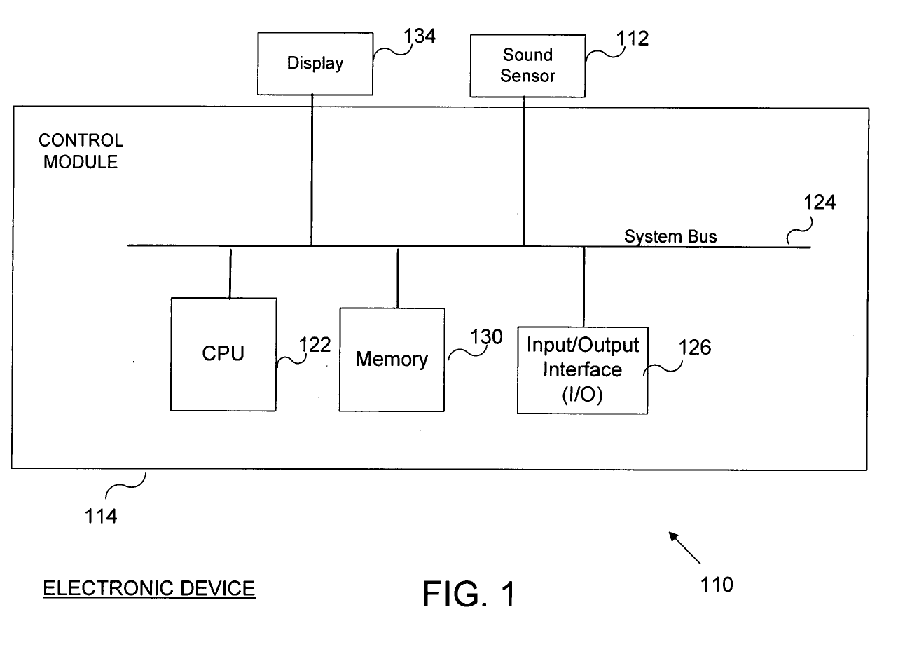

Referring now to FIG. 1, a block diagram for one embodiment of an electronic device 110 is shown, according to the present invention. The FIG. 1 embodiment includes, but is not limited to, a sound sensor 112, a control module 114, and a display 134. In alternate embodiments, electronic device 110 may readily include various other elements or functionalities in addition to, or instead of, certain elements or functionalities discussed in conjunction with the FIG. 1 embodiment.

In accordance with certain embodiments of the present invention, electronic device 110 may be embodied as any appropriate electronic device or system. For example, in certain embodiments, electronic device 110 may be implemented as a computer device, a personal digital assistant (PDA), a cellular telephone, a television, a game console, and as part of entertainment robots such as AIBO™ and QRIO™ by Sony Corporation.

In the FIG. 1 embodiment, electronic device 110 utilizes sound sensor 112 to detect and convert ambient sound energy into corresponding audio data. The captured audio data is then transferred over system bus 124 to CPU 122, which responsively performs various processes and functions with the captured audio data, in accordance with the present invention.

In the FIG. 1 embodiment, control module 114 includes, but is not limited to, a central processing unit (CPU) 122, a memory 130, and one or more input/output interface(s) (I/O) 126. Display 134, CPU 122, memory 130, and I/O 126 are each coupled to, and communicate, via common system bus 124. In alternate embodiments, control module 114 may readily include various other components in addition to, or instead of, those components discussed in conjunction with the FIG. 1 embodiment.

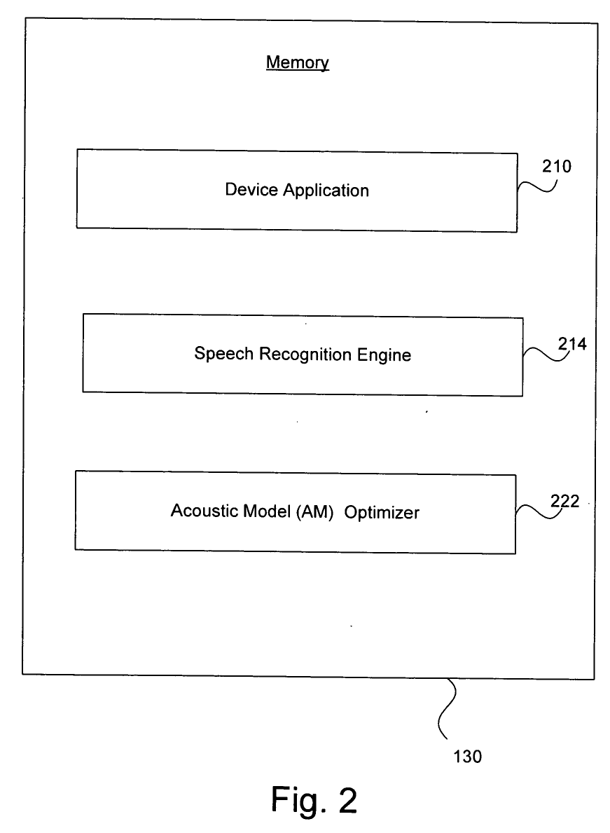

In the FIG. 1 embodiment, CPU 122 is implemented to include any appropriate microprocessor device. Alternately, CPU 122 may be implemented using any other appropriate technology. For example, CPU 122 may be implemented as an application-specific integrated circuit (ASIC) or other appropriate electronic device. In the FIG. 1 embodiment, I/O 126 provides one or more effective interfaces for facilitating bi-directional communications between electronic device 110 and any external entity, including a system user or another electronic device. I/O 126 may be implemented using any appropriate input and/or output devices. The functionality and utilization of electronic device 110 are further discussed below in conjunction with FIG. 2 through FIG. 9.

Referring now to FIG. 2, a block diagram for one embodiment of the FIG. 1 memory 130 is shown, according to the present invention. Memory 130 may comprise any desired storage-device configurations, including, but not limited to, random access memory (RAM), read-only memory (ROM), and storage devices such as floppy discs or hard disc drives. In the FIG. 2 embodiment, memory 130 stores a device application 210, speech recognition engine 214, and an acoustic model (AM) optimizer 222. In alternate embodiments, memory 130 may readily store other elements or functionalities in addition to, or instead of, certain elements or functionalities discussed in conjunction with the FIG. 2 embodiment.

In the FIG. 2 embodiment, device application 210 includes program instructions that are executed by CPU 122 (FIG. 1) to perform various I/O functions and operations for electronic device 110. The particular nature and functionality of device application 210 varies depending upon factors such as the type and particular use of the corresponding electronic device 110.

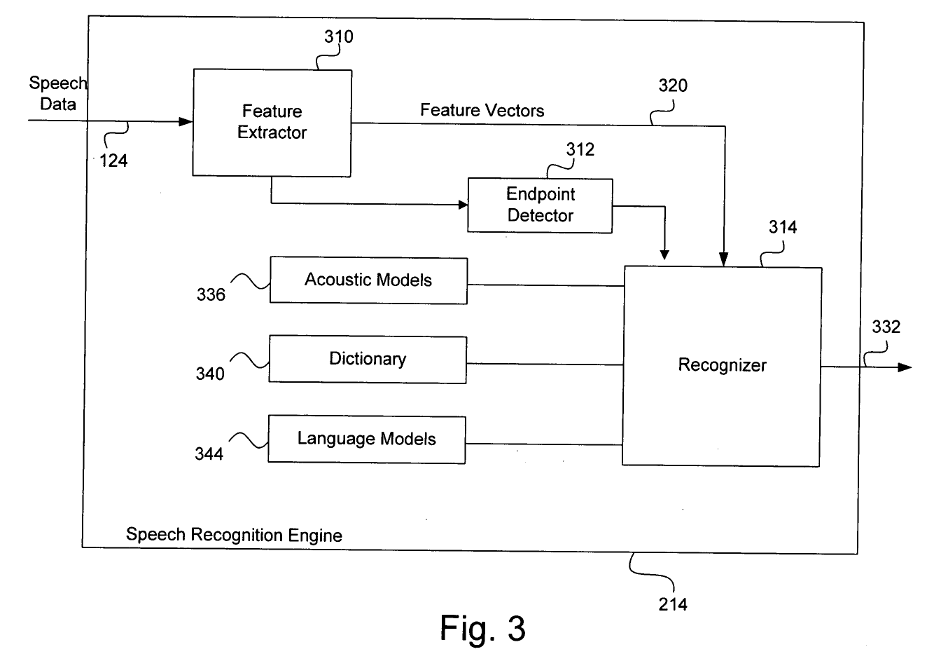

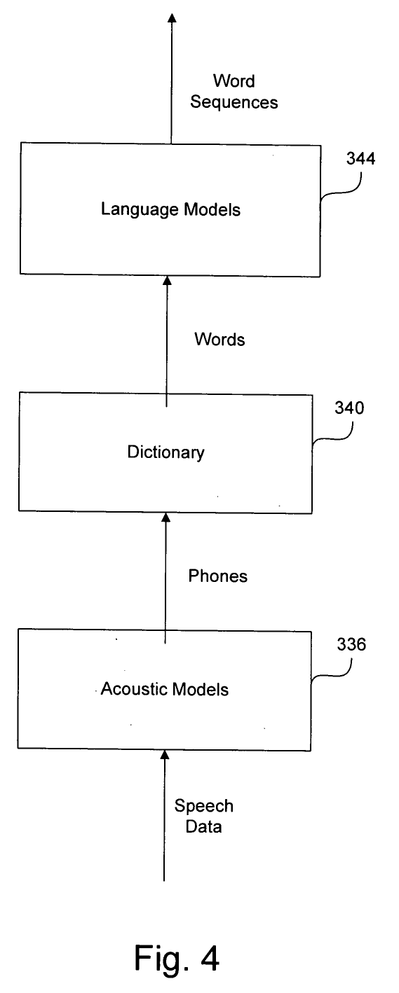

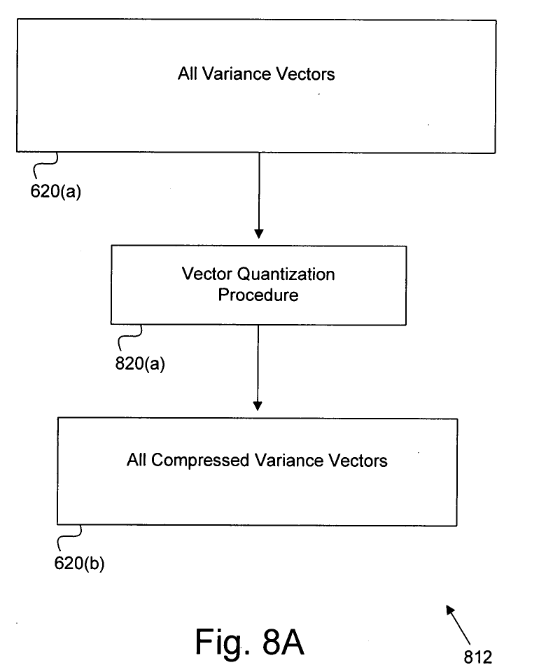

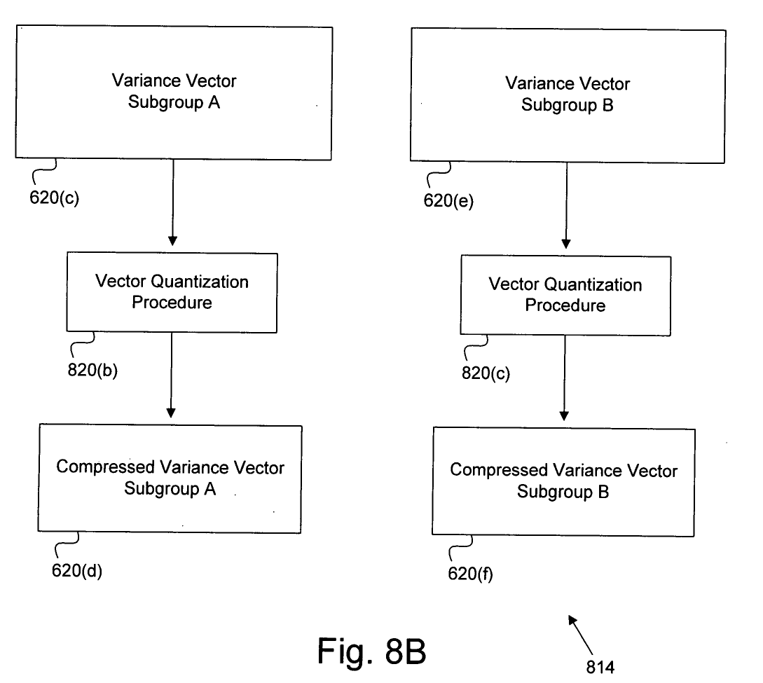

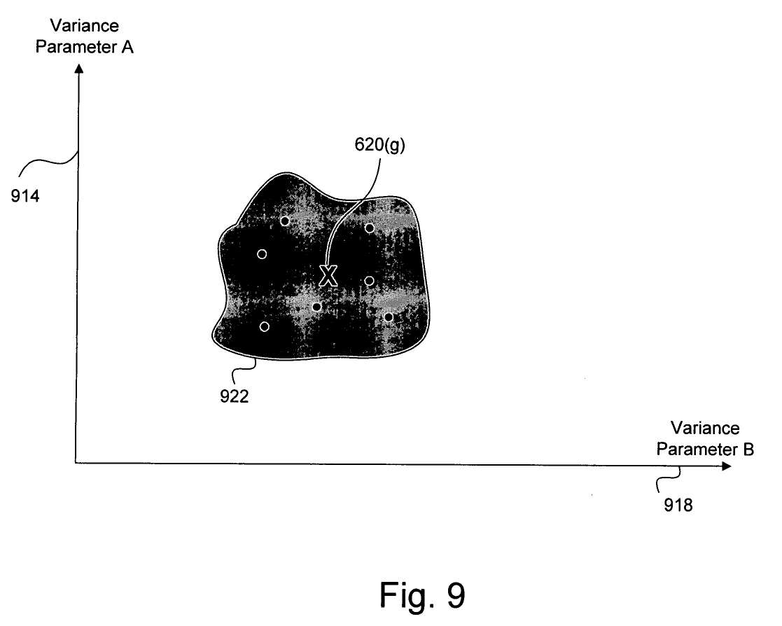

In the FIG. 2 embodiment, speech recognition engine 214 includes one or more software modules that are executed by CPU 122 to analyze and recognize input sound data. Certain embodiments of speech recognition engine 214 are further discussed below in conjunction with FIGS. 3-4. In the FIG. 2 embodiment, electronic device 110 may utilize AM optimizer 222 to optimally implement acoustic models for use by speech recognition engine 214 in effectively performing speech recognition procedures. The optimization of acoustic models by AM optimizer 222 is further discussed below in conjunction with FIG. 8A through FIG. 9.

Referring now to FIG. 3, a block diagram for one embodiment of the FIG. 2 speech recognition engine 214 is shown, in accordance with the present invention. Speech recognition engine 214 includes, but is not limited to, a feature extractor 310, an endpoint detector 312, a recognizer 314, acoustic models 336, dictionary 340, and language models 344. In alternate embodiments, speech recognition engine 214 may readily include various other elements or functionalities in addition to, or instead of, certain elements or functionalities discussed in conjunction with the FIG. 3 embodiment.

In the FIG. 3 embodiment, sound sensor 112 (FIG. 1) provides digital speech data to feature extractor 310 via system bus 124. Feature extractor 310 responsively generates corresponding representative feature vectors, which are provided to recognizer 314 via path 320. Feature extractor 310 further provides the speech data to endpoint detector 312, and endpoint detector 312 responsively identifies endpoints of utterances represented by the speech data to indicate the beginning and end of an utterance in time. Endpoint detector 312 then provides the endpoints to recognizer 314.

In the FIG. 3 embodiment, recognizer 314 is configured to recognize words in a vocabulary that is represented in dictionary 340. The vocabulary represented in dictionary 340 corresponds to any desired sentences, word sequences, commands, instructions, narration, or other audible sounds that are supported for speech recognition by speech recognition engine 214.

In practice, each word from dictionary 340 is associated with a corresponding phone string (string of individual phones) which represents the pronunciation of that word. Acoustic models 336 (such as Hidden Markov Models) for each of the phones are selected and combined to create the foregoing phone strings for accurately representing pronunciations of words in dictionary 340. Recognizer 314 compares input feature vectors from line 320 with the entries (phone strings) from dictionary 340 to determine which word produces the highest recognition score. The word corresponding to the highest recognition score may thus be identified as the recognized word.

Speech recognition engine 214 also utilizes language models 344 as a recognition grammar to determine specific recognized word sequences that are supported by speech recognition engine 214. The recognized sequences of vocabulary words may then be output as recognition results from recognizer 314 via path 332. The operation and utilization of speech recognition engine 214 are further discussed below in conjunction with the embodiment of FIG. 4.

Referring now to FIG. 4, a block diagram illustrating functionality of the FIG. 3 speech recognition engine 214 is shown, in accordance with one embodiment of the present invention. In alternate embodiments, the present invention may readily perform speech recognition procedures using various techniques or functionalities in addition to, or instead of, certain techniques or functionalities discussed in conjunction with the FIG. 4 embodiment.

In the FIG. 4 embodiment, speech recognition engine 214 receives speech data from sound sensor 112, as discussed above in conjunction with FIG. 3. Recognizer 314 (FIG. 3) from speech recognition engine 214 sequentially compares segments of the input speech data with acoustic models 336 to identify a series of phones (phone strings) that represent the input speech data.

Recognizer 314 references dictionary 340 to look up recognized vocabulary words that correspond to the identified phone strings. The recognizer 314 then utilizes language models 344 as a recognition grammar to form the recognized vocabulary words into word sequences, such as sentences, phrases, commands, or narration, which are supported by speech recognition engine 214. Various techniques for optimally implementing acoustic models are further discussed below in conjunction with FIG. 8A through FIG. 9.

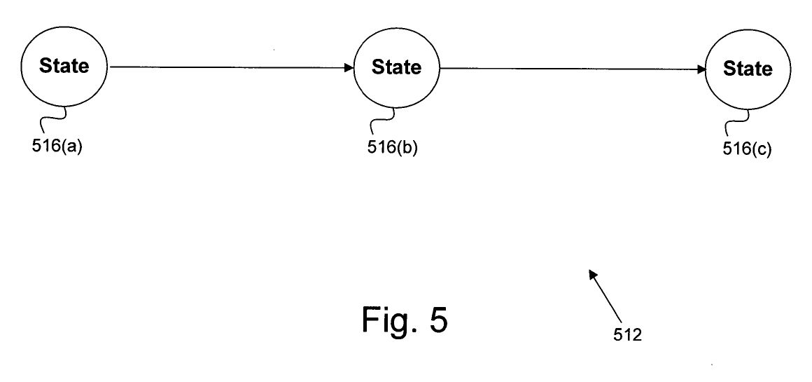

Referring now to FIG. 5, a diagram for one embodiment of an acoustic model 512 is shown, in accordance with the present invention. In other embodiments, acoustic model 512 may be implemented in any other appropriate manner. For example, acoustic model 512 may include any number of states 516 that are arranged in any effective configuration. In addition, the acoustic models 336 shown in foregoing FIGS. 3 and 4 may be implemented in accordance with the embodiment discussed in conjunction with the FIG. 5 acoustic model 512.

In the FIG. 5 embodiment, acoustic model 512 represents a given phone from a supported phone set that is used to implement a speech recognition engine. Acoustic model 512 includes a first state 516(a), a second state 516(b) and a third state 516(c) that collectively model the corresponding phone in a temporal sequence that progresses from left to right as depicted in the FIG. 5 embodiment.

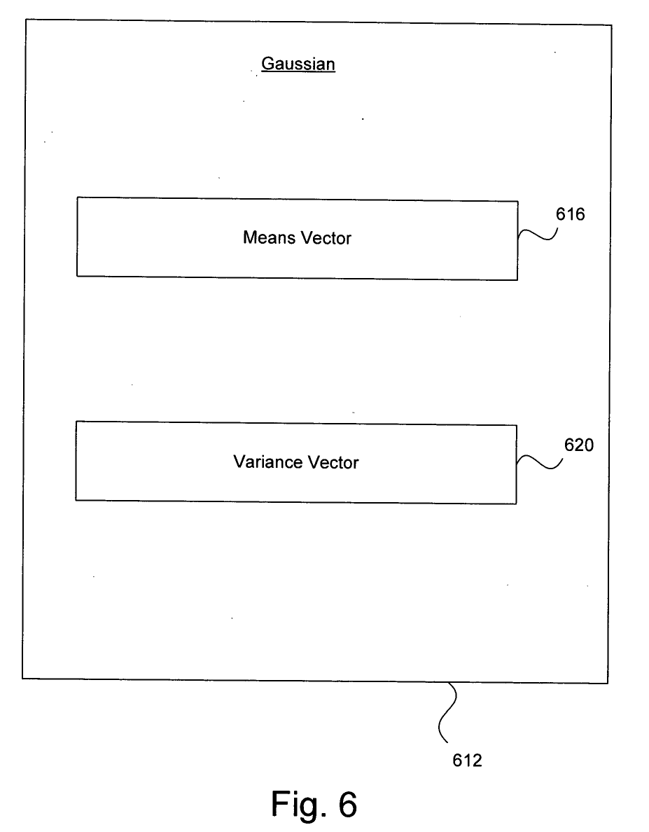

Each state 516 of acoustic model 512 is defined with respect to a phone context that includes information from either or both of a preceding phone and a succeeding phone. In other words, states 516 of acoustic model 512 may be based upon context information from either or both of an immediately adjacent preceding phone and an immediately adjacent succeeding phone with respect to the current phone that is modeled by acoustic model 512. The implementation of acoustic model 512 is further discussed below in conjunction with FIGS. 6-9.

Referring now to FIG. 6, a diagram of a Gaussian 612 is shown, in accordance with one embodiment of the present invention. In the FIG. 6 embodiment, Gaussian 612 includes, but is not limited to, a means vector 616 and a variance vector 620. In alternate embodiments, Gaussians 612 may be implemented with components and configurations in addition to, or instead of, certain components and configurations discussed in conjunction with the FIG. 6 embodiment.

In certain embodiments of the present invention, each state 516 of an acoustic model 512 (FIG. 5) typically includes one or more Gaussians 612 that function as pattern-matching machines that a recognizer 314 (FIG. 3) compares to input speech data to perform speech recognition procedures. In the FIG. 6 embodiment, means vector 616 includes a set of means parameters that each correspond to a different feature from a feature vector created by feature extractor 310 (FIG. 3). Similarly, variance vector 620 includes a set of variance parameters that also each correspond to a different feature from the feature vector created by feature extractor 310 (FIG. 3).

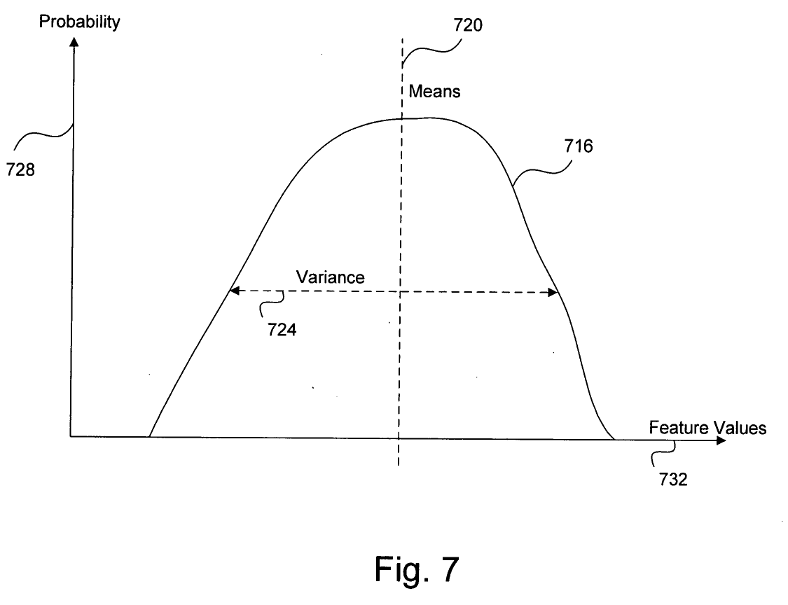

The means parameters and variance parameters may be utilized to calculate transition probabilities for a corresponding state 516. The means parameters and variance parameters typically occupy a significant amount of memory space. Furthermore, the variance parameters have a relatively less important role (as compared, for example, to the means parameters) in determining overall accuracy characteristics of speech recognition procedures. In accordance with the present invention, a variance vector quantization procedure is therefore be utilized for combining similar original variance vectors into a single compressed variance vector to thereby conserve memory resources while preserving a satisfactory level of speech recognition accuracy. One embodiment illustrating an exemplary means parameter and an exemplary variance parameter for a given Gaussian 612 is shown below in conjunction with the embodiment of FIG. 7.

Referring now to FIG. 7, a graph illustrating a mean parameter 720 and a variance parameter 724 is shown, in accordance with one embodiment of the present invention. In alternate embodiments, means parameters and variance parameters may be derived with techniques and characteristics in addition to, or instead of, certain techniques and characteristics discussed in conjunction with the FIG. 7 embodiment.

In the FIG. 7 embodiment, a graph shows a Gaussian curve 716 for a given Gaussian 612 (FIG. 6). The FIG. 7 graph includes feature values for the corresponding Gaussian 612 on a horizontal axis 732, and also shows the probability of having an input feature vector observed in a given state generated with the Gaussian 612 on a vertical axis 728. In the FIG. 7 embodiment, mean parameter 720 may be described as an average of feature values for the corresponding Gaussian 612. In addition, variance parameter 724 may be described as a specific dispersion with respect to the corresponding means parameter 720.

Referring now to FIG. 8A, a diagram illustrating a block variance quantization procedure 812 is shown, in accordance with one embodiment of the present invention. In alternate embodiments, various variance quantization procedures may be implemented with techniques, elements, or functionalities in addition to, or instead of, certain configurations, elements, or functionalities discussed in conjunction with the FIG. 8A embodiment.

In the FIG. 8A embodiment, a set of original acoustic models 512 (FIG. 5) are initially trained using a training database. A vector compression target value is defined to specify a final target number of compressed variance vectors for utilization in optimized acoustic models 512. An acoustic model (AM) optimizer 222 (FIG. 2) then accesses all variance vectors 620(a) from all original acoustic models 512.

AM optimizer 222 then performs a block vector quantization procedure 820(a) upon all variance vectors 620(a) to produce a single set of all compressed variance vectors 620(b). The set of all compressed variance vectors 620(b) may then be utilized to implement the optimized acoustic models 512 for performing speech recognition procedures. One embodiment for performing vector quantization procedures is further discussed below in conjunction with FIG. 9.

Referring now to FIG. 8B, a diagram illustrating subgroup variance quantization procedures 814 is shown, in accordance with the present invention. In alternate embodiments, variance quantization procedures may be implemented with techniques, elements, or functionalities in addition to, or instead of, certain configurations, elements, or functionalities discussed in conjunction with the FIG. 8B embodiment.

In the FIG. 8B embodiment, a set of original acoustic models 512 (FIG. 5) are initially trained on a given representative training data base. A subgroup category may be defined by utilizing any appropriate techniques. For example, a subgroup category may be defined at the phone level, at the state level, or at a state cluster level (a cluster of two or more states), depending upon the level of granularity desired when performing the corresponding subgroup vector quantization procedures.

In the FIG. 8B embodiment, acoustic model (AM) optimizer 222 (FIG. 2) then separately accesses the variance vector subgroups for the original acoustic models 512. For purposes of illustration, in the FIG. 8B embodiment, only two subgroups are shown (subgroup A 620(c) and subgroup B 620(e) ). However, any desired number of subgroups may readily be implemented. A vector compression factor is defined to specify a compression rate for each subgroup. For example, a vector compression factor of four would compress thirty-six original variance vectors 620(a) into six compressed variance vectors 620(b).

AM optimizer 222 then performs separate subgroup vector quantization procedures (820(b) and 820(c) ) upon the variance vector subgroups (620(c) and 620(e)) to produce corresponding compressed variance vector subgroups (620(d and 620(f). Each compressed variance vector subgroup may then be utilized to implement corresponding optimized acoustic models 512 for performing speech recognition procedures. One embodiment for performing vector quantization procedures is further discussed below in conjunction with FIG. 9.

FIG. 9 is a graph illustrating an exemplary vector quantization procedure in accordance with one embodiment of the present invention. For purposes of clarity, the FIG. 9 example is presented as a two-dimensional graph showing variance vectors 620 (FIG. 6) with only two variance parameters each. However, variance vectors 620 having any desired number of variance parameters are equally contemplated. The FIG. 9 graph is presented for purposes of illustration, and in alternate embodiments, vector quantization procedures may be performed with techniques and components in addition to, or instead of, certain techniques and components discussed in conjunction with the FIG. 9 embodiment.

The FIG. 9 graph includes a vertical axis 914, showing a variance parameter A, and also includes a horizontal axis 918 showing a variance parameter B. The FIG. 9 graph includes a variance vector region 922 that represents a grouping of relatively similar original variance vectors from corresponding Gaussians 612 (FIG. 6) shown as individual black dots. In certain embodiments, similarity of original variance vectors may be established by comparing their respective variance parameters.

In the FIG. 9 embodiment, acoustic model (AM) optimizer 222 (FIG. 2) performs a vector quantization procedure upon the original variance vectors in variance vector region 922 to produce a single compressed variance vector 620(g) by utilizing any appropriate techniques. For example, AM optimizer 222 may calculate compressed variance vector 620(g) to be the average of the original variance vectors in variance vector region 922. The single compressed variance vector 620(g) may then be utilized in conjunction with each original Gaussian 612 to thereby significantly conserve memory resources needed to implement a complete set of acoustic models 512 for performing speech recognition procedures. For at least the foregoing reasons, the present invention therefore provides system and method for efficiently implementing variance vectors for speech recognition.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A system for implementing a speech recognition engine, comprising:
acoustic models that said speech recognition engine utilizes to perform speech recognition procedures; and
an acoustic model optimizer that performs a vector quantization procedure upon original variance vectors initially associated with said acoustic models, said vector quantization procedure producing a number of compressed variance vectors less than the number of said original variance vectors, said compressed variance vectors then being used in said acoustic models in place of said original variance vectors.

2. The system of claim 1 wherein said vector quantization procedure is performed as a block vector quantization procedure that operates upon all of said original variance vectors to produce a set of said compressed variance vectors.

3. The system of claim 1 wherein said vector quantization procedure is performed as a plurality of subgroup vector quantization procedures that each operates upon a different subgroup of said original variance vectors to produce corresponding subgroups of said compressed variance vectors.

4. The system of claim 1 wherein said acoustic models represent phones from a phone set utilized by said speech recognition engine.

5. The system of claim 1 wherein said original variance vectors and said compressed variance vectors are each implemented to include a different set of individual variance parameters.

6. The system of claim 1 wherein each of said acoustic models is implemented to include a sequence of model states that represent a corresponding phone supported by said speech recognition engine.

7. The system of claim 6 wherein each of said model states includes one or more Gaussians with corresponding mean vectors.

8. The system of claim 7 wherein each of said compressed variance vectors from said vector quantization procedure corresponds to a plurality of said means vectors.

9. The system of claim 1 wherein said compressed variance vectors require less memory resources than said original variance vectors.

10. The system of claim 1 wherein a set of original acoustic models are trained using a training database before performing a block vector quantization procedure.

11. The system of claim 10 wherein a vector compression target value is defined to specify a final target number of said compressed variance vectors.

12. The system of claim 1 wherein said acoustic model optimizer accesses, as a single block unit, all of said original variance vectors from said original acoustic models.

13. The system of claim 12 wherein said acoustic model optimizer collectively performs said block vector quantization procedure upon said single block unit of said original variance vectors to produce a composite set of said compressed variance vectors for implementing said optimized acoustic models.

14. The system of claim 1 wherein a subgroup category is initially defined to specify a granularity level for performing subgroup vector quantization procedures.

15. The system of claim 14 wherein said subgroup category is defined at a phone level.

16. The system of claim 14 wherein said subgroup category is defined at a state-cluster level.

17. The system of claim 14 wherein said subgroup category is defined at a state level.

18. The system of claim 14 wherein said acoustic model optimizer separately accesses subgroups of said original variance vectors according to said subgroup category.

19. The system of claim 14 wherein a vector compression factor is defined to specify a compression rate for performing said subgroup vector quantization procedure upon subgroups of said original variance vectors.

20. The system of claim 14 wherein said acoustic model optimizer performs separate subgroup vector quantization procedures upon selected subgroups of said original variance vectors to produce corresponding compressed subgroups of said compressed variance vectors.

21. A method for implementing a speech recognition engine, comprising:
defining acoustic models for performing speech recognition procedures; and
utilizing an acoustic model optimizer to perform a vector quantization procedure upon original variance vectors initially associated with said acoustic models, said vector quantization procedure producing a number of compressed variance vectors less than the number of said original variance vectors, said compressed variance vectors then being used in said acoustic models in place of said original variance vectors.

22. The method of claim 21 wherein said vector quantization procedure is performed as a block vector quantization procedure that operates upon all of said original variance vectors to produce a set of said compressed variance vectors.

23. The method of claim 21 wherein said vector quantization procedure is performed as a plurality of subgroup vector quantization procedures that each operates upon a different subgroup of said original variance vectors to produce corresponding subgroups of said compressed variance vectors.

24. The method of claim 21 wherein said acoustic models represent phones from a phone set utilized by said speech recognition engine.

25. The method of claim 21 wherein said original variance vectors and said compressed variance vectors are each implemented to include a different set of individual variance parameters.

26. The method of claim 21 wherein each of said acoustic models is implemented to include a sequence of model states that represent a corresponding phone supported by said speech recognition engine.

27. The method of claim 26 wherein each of said model states includes one or more Gaussians with corresponding mean vectors.

28. The method of claim 27 wherein each of said compressed variance vectors from said vector quantization procedure corresponds to a plurality of said means vectors.

29. The method of claim 21 wherein said compressed variance vectors require less memory resources than said original variance vectors.

30. The method of claim 21 wherein a set of original acoustic models are trained using a training database before performing a block vector quantization procedure.

31. The method of claim 30 wherein a vector compression target value is defined to specify a final target number of said compressed variance vectors.

32. The method of claim 21 wherein said acoustic model optimizer accesses, as a single block unit, all of said original variance vectors from said original acoustic models.

33. The method of claim 32 wherein said acoustic model optimizer collectively performs said block vector quantization procedure upon said single block unit of said original variance vectors to produce a composite set of said compressed variance vectors for implementing said optimized acoustic models.

34. The method of claim 21 wherein a subgroup category is initially defined to specify a granularity level for performing subgroup vector quantization procedures.

35. The method of claim 34 wherein said subgroup category is defined at a phone level.

36. The method of claim 34 wherein said subgroup category is defined at a state-cluster level.

37. The method of claim 34 wherein said subgroup category is defined at a state level.

38. The method of claim 34 wherein said acoustic model optimizer separately accesses subgroups of said original variance vectors according to said subgroup category.

39. The method of claim 34 wherein a vector compression factor is defined to specify a compression rate for performing said subgroup vector quantization procedure upon subgroups of said original variance vectors.

40. The method of claim 34 wherein said acoustic model optimizer performs separate subgroup vector quantization procedures upon selected subgroups of said original variance vectors to produce corresponding compressed subgroups of said compressed variance vectors.

41. A system for implementing a speech recognition engine, comprising:
means for defining acoustic models to perform speech recognition procedures; and
means for performing a vector quantization procedure upon original variance vectors initially associated with said acoustic models, said vector quantization procedure producing a number of compressed variance vectors less than the number of said original variance vectors, said compressed variance vectors then being used in said acoustic models in place of said original variance vectors.
